(19) United States
(12) Patent Application Publication
(10) Pub. No.: US 2008/0069928 A1
(43) Pub. Date: Mar. 20, 2008

(54) Preservative Systems for Extending Shelf Life of Food Intermediates Through Microbial and Enzymatic Control in Non-Modified Atmosphere

(76) Inventors: Gregg J. Moder, Roseville, MN (US); Polam V. Reddy, Apple Valley, MN (US); Soumya Roy, Plainville, MA (US); Jean L. Weber, Maple Grove, MN (US); Lauren Franssen Shimek, San Leandro, CA (US); Liza B. Levin, Plymouth, MN (US)

Correspondence Address: Douglas J. Taylor, P.O. Box 1113, Minneapolis, MN, 55440, US

(21) Appl. No.: 11/576,493

(22) PCT Filed: Oct. 6, 2004
(86) PCT No.: PCT/US04/32799

§ 371 Date: Apr. 2, 2007

(51) Int. Cl. A21D 2/00; A21D 2/06; A21D 2/08; A21D 2/14; A21D 2/22; A21D 2/28; A21D 2/30; A21D 8/02

(52) U.S. Cl. 426/271; 426/331; 426/504; 426/532; 426/541; 426/544; 426/549; 426/556; 426/559; 426/654

(57) ABSTRACT

A preservation system for extending the shelf life of a farinaceous food intermediate having a water activity greater than 0.75, the preservative system comprising a chelating agent, at least an antimicrobial acid, and a reducing agent. The method of preparing and extending the shelf life of farinaceous food intermediates and farinaceous food intermediates having long shelf life are also described.

### FIELD OF THE INVENTION

The invention relates generally to preservative systems for extending the shelf life of farinaceous food intermediates having a high water activity, such as doughs, by increasing the effectiveness of preservatives or by minimizing the amount of preservatives using the common ion effect, a chelating agent, an acidified reducing agent, or a combination thereof. The preservative systems of this invention are effective in reducing or inhibiting the occurrences of off-flavors, odors, graying, enzymatic reactions, microorganisms, or a combination thereof in the farinaceous food intermediates. The invention is directed specifically to preservative systems comprising a chelating agent, an antimicrobial acid, and a reducing agent. Furthermore, the invention is directed specifically to preservative systems comprising a reducing agent and a pH value between 5.2 and 5.6. Furthermore, the invention is directed specifically to preservative systems comprising a mixture of at least two different antimicrobial acids, a pH reducing acid having a pKa value of less than or equal to 4.5, the conjugate bases of the antimicrobial acids and the pH reducing acid, and at least two different cations.

### BACKGROUND OF THE INVENTION

Due to the demands and stresses of modern life, many people no longer have the time or desire to create meals, desserts, or snacks from scratch. Instead, people often purchase farinaceous food intermediates, such as ready-to-bake products and ready-to-eat products, that are pre-prepared to avoid all make up and weighing and can be quickly turned into the final food products for human consumption.

In general, the ready-to-bake products and ready-to-eat products are sold in stores or supermarkets where they are placed on shelves at room temperature or in refrigerated condition. When a preservative system is absent, the ready-to-bake products and the ready-to-eat products are prone to microbial failure and enzymatic failure. Even when a preservative system is present to control microbial failure and enzymatic failure, unfavorably changes in the flavor and/or odor of the farinaceous food intermediates may be induced by the preservative. The ready-to-bake products may fail to meet the product requirements or performances. Some examples of product performance failure include a decrease in specific volume and other degradations of quality.

Food performances, such as appearance, flavor, texture and nutritional value, of the farinaceous food intermediates may be significantly impacted by enzymatic failure. Food performances may be influenced by colored chemicals resulting from enzymatic reactions. Enzymatic graying or browning is one of the most important color reactions that affects foods, such as farinaceous food intermediates. The enzymatic graying is catalyzed by the enzyme polyphenol oxidase which is also referred to as phenoloxidase, phenolase, monophenol oxidase, diphenol oxidase, and tyrosinase.

Many food intermediates are farinaceous (i.e., rich in starch) and have a high water content. The farinaceous and moist food intermediates provides the perfect environment for the growth of microorganisms, such as bacteria and molds. Bacteria thrive on many different types of food including sugars and starches, and molds are widely distributed in nature and grow under a variety of conditions in which air and moisture are present. Both bacteria and molds can cause the undesirable spoilage of the farinaceous and moist food intermediates. The manufacturers of such food intermediates have developed many methods to preserve and delay their spoilage. Some common preservation methods include the removal of microorganisms, the use of high temperature or low temperature, the use of radiation, drying, and the use of chemical preservatives as antimicrobial agents.

Drying of food products by reducing their moisture content is one of the most widely used methods of preservation since ancient times. In general, food items having a water activity value of less than 0.75 are stable to almost all microorganisms except for a few rare cases of halophiles and extreme osmophiles. Therefore, dried meat, fruits, and vegetables can be preserved them for a long period of times when their water activities are sufficiently low. However, drying is not suitable for many food intermediates because it is desirable to have a high water content in them.

The use of chemical preservatives, such as vinegar, salts, and nitrates, in preventing food spoilage has been used widely since ancient times. Modern chemicals preservatives for foods can be classified as inorganic preservatives, organic preservatives, and gases, such as carbon dioxide, ethylene oxide, sulfur dioxide, and ozone. Some inorganic preservatives include mineral acids (e.g., sulfuric acid, hydrochloric acid, and nitric acid, and phiosporic acid), salts (e.g., sodium chloride, nitrates, sulfites), and hydrogen peroxide. Some organic preservatives include organic acids (e.g., acetic acid, propionic acid, sorbic acid, and benzoic acid), phenolic compounds (e.g., alkylparabens), and organic acid salts (e.g. acetates, propionates, sorbates, and benzoates). In general, the organic acids and their salts should be used in a rather acidic condition to be effective as antimicrobial agents. For examples, acetic acid, propionic acid, sorbic acid, and benzoic acid generally are in a pH range of 3.0-5.0, 2.5-5.0, 3.0-6.5, and 2.5-4.0 respectively. However, many food intermediates have a pH higher than 5.0 and such a high pH renders most of the above acidic anti-microbial agents ineffective.

### SUMMARY OF THE INVENTION

Disclosed herein are preservative systems for extending the shelf life of farinaceous food intermediates having a high water activity by increasing the effectiveness of preservatives or by minimizing the amount of preservatives using the common ion effect, a chelating agent, an acidified reducing agent, or a combination thereof. The preservative systems of this invention are effective in reducing or inhibiting the occurrences of off-flavors, odors, graying, enzymatic reactions, microorganisms, or a combination thereof in the farinaceous food intermediates.

In a first aspect, this invention features a preservation system for extending the shelf life of a farinaceous food intermediate having a water activity greater than 0.75, the preservative system comprising a chelating agent, an antimicrobial acid, and a reducing agent.

In a second aspect, this invention features a method of preparing a farinaceous food intermediate having a water activity greater than 0.75, the method comprising the step of mixing flour with a mixture of water, a chelating agent, an antimicrobial acid, and a reducing agent.

In a third aspect, this invention features a farinaceous food intermediate having a water activity greater than 0.75, the farinaceous food intermediate comprising flour, water, a chelating agent, an antimicrobial acid, and a reducing agent.

In a fourth aspect, this invention features a preservation system for extending the shelf life of a farinaceous food intermediate having a water activity greater than 0.75 and a pH value between 5.2 and 5.6, the preservative system comprising a reducing agent.

In a fifth aspect, this invention features a method of preparing a farinaceous food intermediate having a water activity greater than 0.75 and a pH value between 5.2 and 5.6, the method comprising the step of mixing flour with a mixture of water and a reducing agent.

In a sixth aspect, this invention features a farinaceous food intermediate having a water activity greater than 0.75 and a pH value between 5.2 and 5.6, the farinaceous food intermediate comprising flour, water, and a reducing agent.

In a seventh aspect, this invention features a preservation system for extending the shelf life of a farinaceous food intermediate having a water activity greater than 0.75, the preservative system comprising a mixture of at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids.

In an eighth aspect, this invention features a method of preparing a farinaceous food intermediate having a water activity greater than 0.75, the method comprising the step of mixing flour with a mixture of water, at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids.

In a ninth aspect, this invention features a farinaceous food intermediate having a water activity greater than 0.75, the farinaceous food intermediate comprising flour, water, at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids.

In a tenth aspect, this invention features a preservation system for extending the shelf life of a farinaceous food intermediate having a water activity greater than 0.75 and a pH value between 5.2 and 5.6, the preservative system comprising a chelating agent and a reducing agent.

The above summary of the various embodiments of the invention is not intended to describe each illustrated embodiment or every implementation of the invention. The figures in the detailed description that follow more particularly exemplify these embodiments.

### DETAILED DESCRIPTION OF THE INVENTION

This invention is directed to a preservation system for use in preserving farinaceous food intermediates having a water activity greater than 0.75. In some embodiments of interest, the preservation system comprises a mixture of a chelating agent, an antimicrobial acid, and a reducing agent. In other embodiments of interest, the preservative system comprising a reducing agent and a pH value between 5.2 and 5.6. In further embodiments of interest, the preservative system comprising a mixture of at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids. In additional embodiments of interest, the preservative system comprising a chelating agent, a reducing agent, and a pH value between 5.2 and 5.6.

The farinaceous food intermediates may comprise a flour and water. The farinaceous food intermediates may be in the form of a dough, a batter, a paste, or semi-finished bakery products. The flour may be selected from the group consisting of wheat flour, rice flour, millet flour, barley flour, rye flour, buckwheat flour, oat flour, brown rice flour, corn flour, potato flour, soy flour, quinoa flour, non-waxy rice flour, wheat germ, amaranth flour, spelt flour, kamut flour, potato starch, casava flour, triticale flour, and combinations thereof. Furthermore, starch, gluten, or a similar protein, such as eggs, may be added to the flour. Some farinaceous flours and farinaceous food intermediates are described in the book edited by Karel Kulp and Robert Loewe, “Batters and Breadings in Food Processing,” published by American Association of Cereal Chemists (1990), and the book by Karel Kulp et al., “Frozen and Refrigerated Doughs and Batters,” published by American Association of Cereal Chemists (1990), all of which are incorporated herein by reference.

In some embodiments of interest, the food intermediates of this invention are unbaked dough products. Unbaked dough products include any dough product wherein it is desirable to achieve organoleptic properties, including taste and texture, that heretofore have required that the dough product be baked or fried. Furthermore, unbaked dough products suitable for use in the present invention also include any dough products wherein it is desirable to produce finished products with increased verticle dimensions over the dimensions which would normally be achievable from baking the raw dough dimensions.

Furthermore, the dough product may be frozen (i.e. below 25° F.), refrigerated (i.e., from about 35° F. to about 50° F.), or fresh (at ambient temperature), prior to baking.

Formulations of each of the above listed unbaked dough products are well known to those of skill in the art, and are readily available to the public in commercial cookbooks, such as “Beard, Beard on Bread,” Ballantine Books, N.Y. (1973), incorporated herein by reference. For example, “Beard on Bread” contains at least one exemplary formulation for many of the above listed dough products. An exemplary formulation for focaccia can be found in Greenstein, “Secrets of a Jewish Baker: Authentic Jewish Rye and Other Breads,” The Crossing Press, Freedom, Calif., pp 112-115, (1993), incorporated herein by reference. An exemplary formulation for beignets can be found in Collin, “The New Orleans Cookbook,” Alfred A. Knopf, Inc., p 200, (1979), incorporated herein by reference. An exemplary formulation for pizza crusts is disclosed in Example 2 of U.S. Pat. No. 5,989,603, incorporated herein by reference.

Generally, the unbaked dough products suitable for use in the present invention are composed with the usual ingredients known to those of skill in the art, e.g., flour, water, an antimicrobial agent, a salt, and a leavening agent, such as yeast, chemical leavening agents, and steam. The food intermediates may contain conventional food additives to provide the desirable properties, such as shelf life, safety, texture, flavor, and smell. For example, in addition to these basic ingredients, the dough products of the present invention may contain sugar or sweeteners, non-fat milk solids, shortening, gums, surfactants and film-forming proteins. The dough products may further comprise effective amounts of adjuvants such as flavoring agents (e.g., monosodium glutamate and yeast), thickeners (e.g., xanthan, pectin, karrageeenen, gelatin, starches, and modified starches and hydrophilic colloids), nutrients (e.g., carbohydrates, proteins, lipids, vitamin C, taurine, and L-carnitine), antioxidants (e.g., butylated hydroxyanisole, butylated hydroxytoluene, propyl gallate, D-sodium isoascorbate, polyphenol, and vitamin E), antimicrobial agents, eggs and egg solids, acidulants, dough conditioners, enzymes, emulsifiers (e.g., diacetyl tartaric and fatty acid esters of glycerol, sucrose esters of fatty acids, propylene glycol ester, lecithin, mono- and diglycerides, and sodium stearoyl lactylate), and sweeteners (e.g., aspartame, potassium acesulfame, saccharin, sorbitol, and xylitol). Some food additives are described in the book by Clyde Stauffer, “Functional Additives for Balkery Foods,” published by Aspen Food Science (1990), which is incorporated herein by reference.

Non-fat milk solids which can be used in the compositions of this invention are the solids of skim milk and include proteins, mineral matter and milk sugar. Other proteins such as casein, sodium caseinate, calcium caseinate, modified casein, sweet dairy whey, modified whey, and whey protein concentrate can also be used in these doughs.

Dry or liquid flavoring agents, fruit and vegetables may also be added to the formulation. These include mustard, potatoes, anchovies, capers, olives, bacon, cocoa, vanilla, chocolate, butter flavor, coconut, peppermint, pineapple, cherry, nuts, spices, salts, poppy or sesame seeds, onion, garlic, cheese, tomatoes, scallions, oat bran, jalapeno peppers, cinnamon, raisins, chocolate chips, apples, berries, bananas, walnuts, lemon and flavor enhancers, among others.

Acidulants commonly added in foods include, but are not limited to, lactic acid, fumaric acid, adipic acid, citric acid, tartaric acid, maleic acid, acetic acid, phosphoric acid, hydrochloric acid, natural fruit juices, and juice concentrates.

Dough conditioners commonly added to dough products include potassium sorbate, L-cysteine hydrochloride, mono- and diglycerides, polysorbates, sodium bisulfite, sodium stearoyl lactylate, ascorbic acid and diacetyltartaric acid esters of mono- and di-glycerides (DATEM). These conditioners serve to add functionality, reduce mix times, provide softness to the doughs to which they are added, and increasing processability during sheeting and forming.

In further embodiments of interest, the unbaked dough products include, but are not limited to, puff pastries, short crust pastries, pie doughs, cookie doughs, and yeast leavened doughs such as Danishes and bread type of products. Cookie doughs generally contain one or more types of flour that contributes to the structure of the dough. Different flours lend different texture, taste and appearance to a baked good. Wheat flour is the most commonly used in baked goods and in most baked foods is the primary ingredient. Alternatively, other flours such as corn flour, rice flour and the like can be used individually or in combination with wheat flour as the grain constituent. Depending upon dietary requirements, cookie dough can comprise a flourless composition, such as flourless peanut butter cookie dough, in which the grain constituent is replaced primarily with peanut butter, sugar and egg.

The doughs of this invention also generally include leavening agents that increase the volume and alter the texture of the final baked good. Such leavening agents can be either chemical leavening agents or yeast.

Chemical leavening typically involves the interaction of at least one leavening acid and at least one leavening base. The leavening acid generally triggers the release of carbon dioxide from the leavening base upon contact with moisture. The carbon dioxide gas aerates the dough during mixing and/or baking to provide a light, porous cell structure, fine grain and a texture with a desirable appearance and palatability.

Sodium bicarbonate, or baking soda, functions as the leavening base, which is the primary source of carbon dioxide in many chemical leavening systems. Sodium bicarbonate tends to be both chemically stable and inexpensive to produce. Other leavening bases call include potassium bicarbonate, ammonium carbonate, ammonium bicarbonate and the like.

Leavening bases can be modified in order to alter the way in which they function. For example, leavening bases can be encapsulated. By encapsulating leavening bases, the onset of the leavening reaction can be delayed by requiring the encapsulating material to dissolve prior to the onset of the leavening reaction. Generally, the invention can utilize modified or non-modified leavening bases as part of the chemical leavening system.

Leavening acids include sodium or calcium salts or ortho, pyro and complex phosphoric acids in which at least two active hydrogen ions are attached to the molecule. Baking acids include compounds such as monocalcium phosphate monohydrate (MCP), monocalcium phosphate anhydrous (AMCP), sodium acid pyrophosphate (SAPP), sodium aluminum phosphate (SALP), dicalcium phosphate dehydrate (DPD), dicalcium phosphate (DCP), sodium aluminum sulfate (SAS), glucono-delta-lactone (GDL), potassium hydrogen tartrate (cream of tartar) and the like.

The doughs of the invention can also contain additional ingredients. Some such additional ingredients can be used to modify the texture of the dough. Texture modifying agents can improve many properties of the dough, such as viscoelastic properties, plasticity, or dough development. Examples of texture modifying agents include fats, emulsifiers, hydrocolloids, and the like.

Shortening also helps to improve the volume, grain and texture of the final product. Shortening also has a tenderizing effect and improves overall palatability and flavor of a baked good. Natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, grapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such lecithin, mono- and diglycerides of fatty acids, propylene glycol mono- and diesters of fatty acids, glyceryl-lacto esters of fatty acids, ethoxylated mono- and diglycerides and the like.

Hydrocolloids can be added to dough formations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, locust bean gum, carageenan, alginate, and the like.

Doughs can also include flavoring such as sweeteners, spices and specific flavorings such as fruit, vanilla, butter, mint and the like. Sweeteners include regular and high fructose corn syrup, sucrose (cane or beet sugar), dextrose and maltose. In addition to flavoring the baked good, sweeteners such as sugar can increase the moisture retention of a baked good, thereby increasing its tenderness.

The mixing times, temperatures and speeds for processing the dough product are known in conventional dough processing technology, but may vary depending on the particular product being prepared. Particular mixing times, temperatures and speeds for particular dough products can be readily determined by one skilled in the art using conventional processing technology.

Water activity (A_{w}) is a significant factor in determining the quality and safety of foods, particularly farinaceous food intermediates having a high water activity. Water Activity (A_{w}) is the measurement of the availability of water in a substance. In general, the microbial and chemical stability of a food product, such as a food intermediate, is directly related to how much water is available for biological or chemical reactions. Therefore, the water activity of the food product affects their shelf life, safety, texture, flavor, and smell. While the temperature, pH and several other factors can influence if and how fast organisms will grow in a food intermediate, its water activity may be the most important factor in controlling its spoilage. In general, most bacteria do not grow at water activities below 0.91, and most molds cease to grow at water activities below 0.75. By measuring the water activity of the food intermediates, it is possible to predict whether microorganisms will cause the spoilage of the food intermediates. The water activity of the food intermediates determines the lower limit of available water for microbial growth in them. In addition to influencing food spoilage, water activity can have a major impact on the color, taste, and aroma of foods.

The water activity of a food intermediate can be determined from the relative humidity of the air surrounding the food intermediate in a sealed enclosure when the air and the food intermediate are at equilibrium. At equilibrium, the water activity of the food intermediate and the relative humidity of the air are equal. The measurement taken at equilibrium is called an equilibrium relative humidity (% ERH). Water Activity may be expressed in many different ways and one particular useful way is defined: A_{w}=% ERH/100. Two different types of water activity measuring instruments are commercially available. One uses chilled-mirror dew point technology while the other measures relative humidity with sensors that change electrical resistance or capacitance. The major advantages of the chilled-mirror dew point method are accuracy, speed, ease of use and precision. Capacitance sensors have the advantage of being inexpensive, but are not typically as accurate or as fast as the chilled-mirror dewpoint method. The determination of water activity has been widely described in the literature. One non-limiting particular reference in the literature is Cauvain et al., “Bakery Food Manufacture and Quality: Water Control and Effects,” Blackwell Publishing, Ltd., Ames, Iowa (2000), which is incorporated herein by reference.

Some substances, such as milk and juices, with an A_{w} approaching 1.0 have a very high water activity. Other substances, such as pasta or dried milk, with an A_{w} in the range of 0.2 to 0.6 have a very low water activity. The chemical and microbial stability of a food product is directly related to its water activity. In general, a food product having an A_{w} of less than 0.75 should be stable to almost all organisms except for a few rare cases of halophiles and extreme osmophiles. Some food intermediates have an A_{w} higher than 0.8 and microorganisms will cause the spoilage of the food intermediates if they are not properly preserved. In some embodiments of this invention, the food intermediates have an A_{w} higher than 0.91 so that both bacteria and molds can grow and cause food spoilage.

All living organisms, large and small, have at least a cell as the basic unit. The cell is a tiny living factory capable of reproducing itself and of converting simple food substances into energy and new cell material. Large organisms, including people, are composed of billions of cells with many different roles. Microorganisms, on the other hand, are made up of a very few or even a single cell capable of carrying on all of life's processes. The main parts of the cell are the nucleus, cytoplasm and cell wall. The nucleus is the control center. It directs cell division or the formation of new cells. The cytoplasm contains the parts that convert food material into energy and new cell material. The cell wall or membrane holds everything together and controls the passage of material into and out of the cell. To be used by microorganisms, a food substance must pass into the cell where it can be processed into energy and new cell material. Because most foods are too complex to move into a cell, they must be broken down into simpler substances. Enzymes inside the cell wall do this by increasing the rate of biochemical reactions. Produced within the cell, enzymes move through the cell wall to break down the food on the outside into a form microorganisms can use.

In some embodiments, the preservative system described herein can comprise at least an antimicrobial acid that can pass through cell membranes and transport protons therein to reduce pH and/or to inhibit enzyme activities. While not wanting to be limited by theory, according to one antimicrobial activity model for antimicrobial agents comprising an antimicrobial acid, only the undissociated or un-ionized antimicrobial acid has antimicrobial property because only it can pass through the membrane of the cell wall. After passing the cell wall, the antimicrobial acid dissociates inside the cell and thus causes a decrease in pH. At a low pH, the enzymes inside the cell wall are less active and consequently the activity of the microorganisms is inhibited. The dissociated or ionized form, i.e., the conjugate base of the antimicrobial acid, is unable to pass through the cell membrane. The un-ionized antimicrobial acids dissociate in water to form the conjugate bases (i.e, the carboxylate anions) and H₃O⁺ ions. The equilibrium of the dissociation of the antimicrobial acid is shown below: 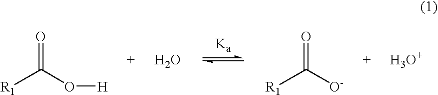
where R₁ comprises an alkyl group, an alkenyl group, an alkynyl group, a heterocyclic group, or an aromatic group.

Some non-limiting examples of the antimicrobial acid that can pass through cell membranes and transport protons therein include acetic acid, dehydroacetic acid, benzoic acid, lactic acid, sorbic acid, propionic acid, and combinations thereof. The selection of an antimicrobial acid for a particular food intermediate depends on, inter alia, the antimicrobial activity of the antimicrobial acid, the pH of the food intermediate, the composition of the food intermediates, the processing and storage conditions, the solubility of the antimicrobial acid, the flavor of the food intermediate, and the cost of the food intermediates. In some embodiments, the amount of the antimicrobial acid is between 0.01 wt % to 2 wt % of the total weight of the food intermediate. In other embodiments, the amount of the antimicrobial acid is between 0.01 wt % to 0.5 wt % of the total weight of the food intermediate.

In general, the antimicrobial effectiveness of a solution of an antimicrobial acid may be increased whenever the concentration of the un-ionized antimicrobial acid is increased. This invention describes novel methods to increase the concentration of the un-ionized antimicrobial acid so as to increase its antimicrobial effectiveness. In some embodiments of interest, the concentration of the un-ionized antimicrobial acid is increased by the common ion effect. On the other hand, the antimicrobial effectiveness of a solution of an antimicrobial acid may be decreased whenever the concentrations of the carboxylate anions and/or H₃O⁺ ions are decreased so as to shift Equilibrium (1) to the right. Described herein are also novel methods of removing compounds that can react with the carboxylate anions and/or H₃O⁺ ions. In some embodiments of interest, the concentration of the un-ionized antimicrobial acid is increased by the using of chelating agents to sequestrate metal ions that can form associated metal salts with the carboxylate anions. As a result, the use of chelating agents may allow the use of a lower level of the antimicrobial acid and thus may improve the flavor of the food intermediates.

The common ion effect is an application of LeChatelier's Principle. Under LeChatelier's Principle, adding a common ion to the above acid solution will increase the concentration of the common ion and place a stress upon the equilibrium. The equilibrium will respond so as to undo the stress of added common ion. This means that the equilibrium will shift to the left to reduce the common ion and to increase the amount of the un-ionized organic acid. Therefore, according to LeChatelier's Principle, if an additional amount of the carboxylate anions, and/or H₃O⁺ ions from a different source is added to Equilibrium (1) above, the position of the equilibrium will shift to the left. Consequently, the amount of the un-ionized antimicrobial acid in the solution will increase.

In some embodiments of interest, the common ion is the H₃O⁺ ion. The concentration of the H₃O⁺ ion in the solution may be increased by the addition of an acid to reduce the pH. In some embodiments of interest, the pH reducing acid has a pKa value of less than or equal to 4.5. Non-limiting examples of the pH reducing acid having a pKa value of less than or equal to 4.5 include citric acid, malic acid, lactic acid, fumaric acid, succinic acid, tartaric acid, phosphoric acid, hydrochloric acid, and combinations thereof. In equilibrium, the equilibrium constant, Kₐ, for the dissociation of the acid can be expressed as Kₐ=[ionized form][H₃O+]/[un-ionized form], which can be rearranged to the following equation:
pH−pKₐ=log {[ionized form]/[un-ionized form]}

When the pH of the solution is the same as the pKa of the antimicrobial acid, the concentration of the ionized form and the concentration of the unionized form are the same. The amount of the unionized antimicrobial acid will exceed the amount of the ionized form if the pH is greater than the pKₐ. Since this is a log relationship, a little change in pH may cause a large increase or decrease in the unionized form.

In some embodiments, the preservative system described herein can comprise at least an acid, in addition to the antimicrobial acid. Many inorganic acids and organic acids may be used to lower the pH for this invention. Some non-limiting examples of inorganic acids include boric acid, hydrochloride acid, phosphoric acid, boric acid salts, and phosphoric acid salts. When an organic acid is used for providing H₃O⁺ common ions, the organic acid (R₂COOH) dissociates in water to provide the H₃O⁺ ions as shown in Equilibrium (2) below: 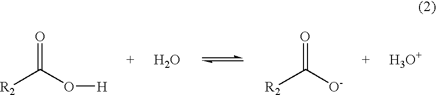
where R₂ comprises an alkyl group, an alkenyl group, an alkynyl group, a heterocyclic group, or an aromatic group. In further embodiments of interest, the organic acid for providing H₃O⁺ common ions may also have reducing property and act as an antioxidant. Some non-limiting examples of suitable reducing organic acid for providing H₃O⁺ common ions include ascorbic acid, citric acid, malic acid, arabinoascorbic acid, ethylene diamine tetraacetic acid, erythrobic acid, and combinations thereof. However, this invention is not limited to reducing organic acids. Other organic acids such as acetic acid, oxalic acid, and formic acid may also be used. In some embodiments, the amount of the organic acid is between 0.01 wt % to 2 wt % of the total weight of the food intermediate. In other embodiments, the amount of the organic acid is between 0.01 wt % to 0.5 wt % of the total weight of the food intermediate.

In other embodiments of interest, the common ion is the carboxylate anion (R₁COO⁻) of the antimicrobial acid (R₁COOH). The concentration of the carboxylate anion in a solution of the antimicrobial acid may be increased by adding to the solution a metal salt of the antimicrobial acid. The metal salt dissociates in water to form the corresponding carboxylate anions and metal cations as represented by Equilibrium (3) below: 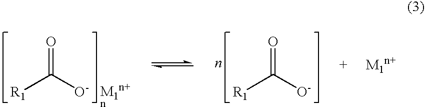
where n is an integer between 1 to 6; M₁ⁿ⁺ is an ammonium ion or a metal ion; and R₁ comprises an alkyl group, an alkenyl group, an alkynyl group, a heterocyclic group, or an aromatic group. The increase in the concentration of the carboxylate anions (R₁COO⁻) shifts the position of Equilibrium (1) to the left to provide a higher concentration of the unionized antimicrobial acid. Furthermore, more carboxylate anions (R₁COO⁻) may be available for Equilibrium (1) if the position of Equilibrium (3) is shifted to the right by the sequestration of the M₁ⁿ⁺ ions with a chelating agent or a sequestrant, such as ethylene diamine tetraacetic acid, salts of ethylene diamine tetraacetic acid (e.g., calcium disodium ethylene diamine tetraacetate, disodium ethylene diamine tetraacetate, and tetrasodium ethylene diamine tetraacetate), citric acid, salts of citric acid (e.g., calcium citrates, potassium citrates, and sodium citrates such as trisodium citrate), esters of diacetyltartaric acid, esters of citric acid (e.g., isopropyl citrates and stearyl citrate), lactic and fatty acid esters of glycerol, pyrophosphates (e.g., dihydrogen pyrophosphate, sodium acid pyrophosphate, and disodium dihydrogen pyrophosphate), hexametaphosphates (e.g., sodium hexametaphosphate and potassium hexametaphosphates), polyphosphates (sodium tripolyphosphate, sodium polyphosphate, and potassium polyphosphate), gluconic acid, salts of gluconic acid (e.g., potassium gluconate and sodium gluconate,) tartaric acid, salts of tartaric acid (e.g., potassium tartrates, potassium sodium tartrate, and sodium tartrates), oxystearin, and adipic acid.

For this invention, the metal salts of the antimicrobial acids act not only as a source of carboxylate common ions, but also are sources of the antimicrobial acids and therefore, are effective antimicrobial agents. The antimicrobial acid may be derived from dissolving metal salts of the antimicrobial acid, such as alkali and alkaline salts of benzoic acid, lactic acid, sorbic acid, and propionic acid, in water. When a metal salt dissociates in water in the presence of H₃O⁺ ions (i.e., an acid), the position of Equilibrium (1) will shift to the left and therefore, the corresponding un-ionized antimicrobial acid is formed. Some non-limiting examples of suitable metal salts of the antimicrobial acids include calcium propionate, sodium propionate, potassium propionate, potassium sorbate, sodium sorbate, and calcium sorbate. Some non-limiting examples of cation suitable for the metal salts of the antimicrobial acids include Li⁺, Na⁺, K⁺, Ca⁺², Zn⁺², Fe⁺², Fe⁺³, Al⁺³, and Mg⁺².

Wheat flour used in dough products may contain many enzymes such as alpha-amylase, protease, polyphenol oxidase, pentosanase, lipoxygenase, lipase, and phosphatase. Under refrigerated or non-refrigerated storage conditions, an enzyme such as polyphenol oxidase (PPO) may trigger enzymatic reactions in the presence of a mixture of water and oxygen so as to cause the development of graying and black spots. PPO activity in food intermediates may be inhibited by adding an acidulant to the food intermediates to reduce the pH to less than 4.5. However, when the pH value is less than 4.5, gluten may not function properly to maintain the unique properties of wheat flour such as the ability to retain gas. Furthermore, off-flavor may also develop at a pH value of less 4.5. Therefore, the use of acidulants for PPO inhibitions may not be very practical. However, a reducing agent, such as ascorbic acid, glutathione, bisulfites, and L-cysteine, may inhibit PPO enzyme activity at a pH value greater than 4.5. In some embodiments of interest, the pH value is between 4.5 and 6.0. In other embodiments of interest, the pH value is between 5.2 and 5.6. The use of a reducing agent at the pH range of approximately 5.2 to 5.6 provides good product performance and reduce or eliminate the off-flavor of the farinaceous food intermediates. However, when the pH in the farinaceous food intermediates reaches 6.0 and beyond, the development of graying and the black spots caused by PPO continues. The graying and black spot development may be controlled by eliminating oxygen in the package with modified atmosphere packaging, such as package filled with carbon dioxide and other inert gases. However, such modified atmosphere packaging increases the cost of the farinaceous food intermediate products.

Non-limiting example of reducing agent include ascorbic acid and its derivatives (e.g., L-ascorbic acid, 2- and 3-phosphate derivatives of ascorbic acid, phosphinate esters of ascorbic acid, and ascorbyl-6-fatty acid esters of ascorbic acid), erythrobic acid and its derivatives (e.g., D-ascorbic acid and sodium erythorbate), glutathione and its derivatives, sulfating agents (e.g., sulfur dioxide, sulfites such as sodium sulfite and sodium hydrogen sulfite, bisulfites such as sodium metabisulfite and potassium metabisulfite), cysteine and its derivatives, and phenolic antioxidants (e.g., butylated hydroxyanisole (BHA), butylated hydroxytoluene (BHT), tertiarybutyl hydroxyquinone (TBHQ), propyl gallate (PG), tocopherols, flavonoid compounds, cinnamic acid derivatives, and coumarins).

In general, the quality of flour may be expressed in terms of its protein content and ash content. The ash content of the flour is an indication of the amount of bran that is contaminating the endosperm in the flour. In general, the ash level for wheat flour is less than 0.55%. In some embodiments of interest, the ash level for wheat flour is less than 0.48%. In other embodiments of interest, the ash level for wheat flour is between 0.4% and 0.48%. The ash level may be obtained by burning a sample of the flour to ash in air or oxygen. The ash level of the sample is the ratio of the weight of the ash to the weight of the sample in percentage.

In some embodiments, the preservative system described herein may comprise at least a chelating agent. The chelating agent may extend the shelf life of the food intermediates by controlling the microbial activities and enzymatic graying activities. In addition, the chelating agents potentially may reduce the required levels of reducing agents and or anti-microbial agents if a synergistic effect exists.

In some embodiments of interest, the concentration of the un-ionized antimicrobial acid is increased by the use of a chelating agent to sequestrate polyvalent metal ions that can form an associated metal salt with the carboxylate anions. The equation of the association is shown below:

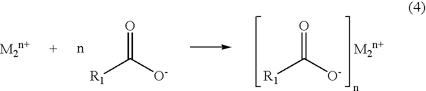

where n is an integer between 2 to 6; M₂ⁿ⁺ is a polyvalent metal ion; and R₁ comprises an alkyl group, an alkenyl group, an alkynyl group, a heterocyclic group, or an aromatic group. The M₂ⁿ⁺ ions may be present in any ingredients of the food intermediates, such as water and flour. Non-limiting examples of the M₂ⁿ⁺ ions include Fe²⁺, Fe³⁺, Ca²⁺, Mg²⁺, Sr²⁺, Ba²⁺, Ca²⁺, Cu²⁺, Cd²⁺, Ni²⁺, Co²⁺, Hg²⁺, Cr³⁺, Al³⁺, and Zn²⁺. The M₂ⁿ⁺ ions may be sequestrated with a chelating agent or a sequestrant, such as ethylene diamine tetraacetic acid, salts of ethylene diamine tetraacetic acid (e.g., calcium disodium ethylene-diamine-tetra-acetate, disodium ethylene diamine tetraacetate, and tetrasodium ethylene diamine tetraacetate), citric acid, salts of citric acid (e.g., calcium citrates, potassium citrates, and sodium citrates such as trisodium citrate) diacetyltartaric, esters of citric acid (e.g., isopropyl citrates and stearyl citrate), lactic and fatty acid esters of glycerol, pyrophosphates (e.g., dihydrogen pyrophosphate, sodium acid pyrophosphate, and disodium dihydrogen pyrophosphate), hexametaphosphates (e.g., sodium hexametaphosphate and potassium hexametaphosphates), polyphosphates (sodium tripolyphosphate, sodium polyphosphate, and potassium polyphosphate), gluconic acid, salts of gluconic acid (e.g., potassium gluconate and sodium gluconate,) tartaric acid, salts of tartaric acid (e.g., potassium tartrates, potassium sodium tartrate, and sodium tartrates), oxystearin, and adipic acid. The chelating agent or sequestrant reacts with the M₂ⁿ⁺ ions to form a soluble metal complex and prevent thereby the M₂ⁿ⁺ ions from reacting with the carboxylate anions (R₁COO⁻). In some embodiments, the amount of the chelating agent is between 0.1 wt % to 1 wt % of the total weight of the food intermediate.

In some embodiments, the preservative system described herein can comprise at least a metal salt. The metal salt may be selected from the group consisting of the chlorides, iodides, and bromides of alkali and alkaline metals, and combinations thereof. In some embodiments of interest, the metal salt is selected from the group consisting of the potassium chloride, sodium chloride, calcium chloride, and combinations thereof. In other embodiments of interest, the cation of the metal salt is different from the cations of the chelating agent and/or the cations of the antimicrobial agent. In further embodiments, the amount of the metal salt is between 0.1 wt % to 2 wt % of the total weight of the food intermediate. In additional embodiments, the amount of the metal salt is between 0.5 wt % to 2 wt % of the total weight of the food intermediate.

The food intermediate may further comprise a food additive selected from the group consisting of acidity modifiers or acidulants, anti-oxidants, colorants, emulsifiers, nutrition intensifiers, sweeteners, thickeners, sugar, non-fat milk solids, shortenings, gums, surfactants, film-forming proteins, flavor agents, and fragrance agents, eggs and egg solids, dough conditioners, and enzymes.

Although various embodiments of the present invention have been disclosed here for purposes of illustration, it should be understood that a variety of changes, modifications and substitutions may be incorporated without departing from either the spirit or scope of the present invention.

The invention will now be described further by way of the following examples.

### EXAMPLES

### Example 1

A puff pastry and short crust dough was made from 700 g of flour, 260 g of water, 17 g of salt, 2 g of potassium sorbate, 4 g of sodium propionate, 0.4 g of ascorbic acid, and 0.024 g of citric acid. The ingredients were mixed in a Kitchen Aid mixer for 1 minute at low speed and then for 5 minutes at high speed. The water activity (A_{w}) of the dough was between 0.95 and 0.96, and the pH was between 5.2 and 5.3. After mixing, the dough was sheeted to 3 mm thickness and cut into 10×10 cm square samples. The dough samples were inoculated with mold spores, and stored at 10° C. until mold colonies appeared on the dough sample surface. Mold appeared in Example 1 after 30 days of inoculation.

### Examples 2(a), 2(b), and 2(c)

Examples 2(a)-(c) were prepared similar to Example 1 except that Sodium Propionate was replaced by Calcium Propionate respectively at the levels of a) 6 g; b) 4 g, c) 2 g. The dough sample was inoculated with mold spores and stored at 10 degrees Centigrade until mold colonies appeared on the dough surface. Mold appeared in Example 2(c) after 60 days of inoculation. No mold appeared in Examples 2(a) and 2(b) up to 60 days of inoculation.

### Example 3(a)

A dough was made from 700 g of flour, 260 g of water, 17 g of salt, 1.6 g of potassium sorbate, 1.7 g of calcium propionate, 0.4 g of ascorbic acid, and 1.3 g of citric acid. The dough was mixed in a Kitchen Aid mixer for 1 minute at low speed and then for 5 minutes at high speed. The pH of the dough was 5.2. The water activity (A_{w}) of the dough was between 0.95 and 0.96. After mixing, the dough was sheeted to 3 mm and cut into 10×10 cm square samples. The dough samples were inoculated with mold spores, and stored at 10° C. until mold colonies appeared on the dough sample surface. Mold and gray dough color did not appear in the samples until 75 days. Furthermore, significant reductions in flavor and odor degradations were observed by a testing panel pf trained evaluators.

### Example 3(b)

Example 3(b) was prepared similar to Example 3(a) except that the amount of citric acid was reduced to 0.5 g and the pH of the dough was 5.4. Mold and gray dough color did not appear in the samples until 60 days.

### Example 3(c)

Example 3(c) was prepared similar to Example 3(a) except that the amount of citric acid was reduced to 0.2 g and the pH of the dough was 5.6. Mold and gray dough color did not appear in the samples until 30 days.

Significant reduction in off-flavors and odors development caused by high level of acidity at the pH<5.4 as well as the lower level of preservatives used, was observed by sensory panel.

### Example 4

A dough was made from 700 g of flour having an average activity of polyphenoloxidase enzyme, 285 g of water, 17 g of salt, 1.8 g of potassium sorbate, 2.2 g of calcium propionate, 0.1 g of ascorbic acid, 0.24 g citric acid, and 2 g sodium hexametaphosphate. The dough was mixed in a Kitchen Aid mixer for 1 minute at low speed and then for 5 minutes at high speed. The pH of the dough was between 5.4 and 5.5. The water activity (A_{w}) of the dough was between 0.95 and 0.96. The dough was stored at 10° C. and its color was monitored by a Minolta calorimeter. Example 4 did not develop gray dough in more than 60 days, whereas the control doughs (i.e., Example 3(a) and 3(b)) developed gray dough within 21 days.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A preservation system for extending the shelf life of a farinaceous food intermediate having a water activity greater than 0.75, the preservative system comprising a chelating agent, at least an antimicrobial acid, and a reducing agent.

2. The preservative system of claim 1 where the chelating agent is selected from the group consisting of ethylene diamine tetraacetic acid, salts of ethylene diamine tetraacetic acid, citric acid, salts of citric acid, esters of diacetyltartaric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

3. The preservative system of claim 1 wherein the antimicrobial acid is selected from the group consisting of acetic acid, dehydroacetic acid, benzoic acid, lactic acid, sorbic acid, and propionic acid.

4. The preservative system of claim 1 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

5. The preservative system of claim 1 wherein the pH of the preservative system is between 5.2 and 5.6.

6. The preservative system of claim 1 comprising two different antimicrobial acids.

7. The preservative system of claim 6 further comprising the salts of the two different antimicrobial acids.

8. The preservative system of claim 7 wherein the cations of the salts of the two different antimicrobial acids are different.

9. A method of preparing a farinaceous food intermediate having a water activity greater than 0.75, the method comprising the step of mixing flour with a mixture of water, a chelating agent, an antimicrobial acid, and a reducing agent.

10. The method of claim 9 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

11. The method of claim 9 wherein the antimicrobial acid is selected from the group consisting of acetic acid, dehydroacetic acid, benzoic acid, lactic acid, sorbic acid, and propionic acid.

12. The method of claim 9 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

13. The method of claim 9 wherein the pH of the farinaceous food intermediate is between 5.2 and 5.6.

14. A farinaceous food intermediate having a water activity greater than 0.75, the farinaceous food intermediate comprising flour, water, a chelating agent, an antimicrobial acid, and a reducing agent.

15. The farinaceous food intermediate of claim 14 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

16. The farinaceous food intermediate of claim 14 wherein the antimicrobial acid is selected from the group consisting of acetic acid, dehydroacetic acid, benzoic acid, lactic acid, sorbic acid, and propionic acid.

17. The farinaceous food intermediate of claim 14 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

18. The farinaceous food intermediate of claim 14 wherein the farinaceous food intermediate is selected from the group consisting of cookie doughs, puff pastries, short crust pastries, pie doughs, and yeast leavened doughs.

19. The farinaceous food intermediate of claim 14 wherein the flour is selected from the group consisting of wheat flour, rice flour, millet flour, barley flour, rye flour, buckwheat flour, oat flour, brown rice flour, corn flour, potato flour, soy flour, quinoa flour, non-waxy rice flour, wheat germ, amaranth flour, spelt flour, kamut flour, potato starch, casava flour, triticale flour, and combinations thereof.

20. The farinaceous food intermediate of claim 14 further comprising a food additive selected from the group consisting of acidity modifiers, anti-oxidants, colorants, emulsifiers, nutrition intensifiers, sweeteners, thickeners, acidulants, sugar, non-fat milk solids, shortenings, gums, surfactants, film-forming proteins, flavor agents, and fragrance agents, eggs and egg solids, dough conditioners, and enzymes.

21. A preservation system for extending the shelf life of a farinaceous food intermediate having a water activity greater than 0.75 and a pH value between 5.2 and 5.6, the preservative system comprising a reducing agent.

22. The preservation system of claim 21 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

23. The preservation system of claim 21 further comprising a chelating agent.

24. The preservation system of claim 23 wherein the chelating agent is selected from the group consisting of ethylene diamine tetraacetic acid, salts of ethylene diamine tetraacetic acid, citric acid, salts of citric acid, esters of diacetyltartaric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

25. The preservation system of claim 21 further comprising two different antimicrobial acids and the salts of the two different antimicrobial acids where the cations of the salts are different.

26. A method of preparing a farinaceous food intermediate having a water activity greater than 0.75 and pH value between 5.2 and 5.6, the method comprising the steps of:
formulating a dough having a water activity level greater than 0.75 and a pH value between 5.2 and 5.6, the dough including at least a farinaceous flour, water and a reducing agent; and
mixing the farinaceous flour with a mixture of the water and the reducing agent.

27. The method of claim 26 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

28. The method of claim 26 further comprising a chelating agent.

29. The method of claim 28 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

30. The method of claim 26 further comprising two different antimicrobial acids and the salts of the two different antimicrobial acids where the cations of the salts are different.

31. A farinaceous food intermediate having a water activity greater than 0.75 and a pH value between 5.2 and 5.6, the farinaceous food intermediate comprising flour, water, and a reducing agent.

32. The farinaceous food intermediate of claim 31 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

33. The farinaceous food intermediate of claim 31 further comprising a chelating agent.

34. The farinaceous food intermediate of claim 33 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

35. The method farinaceous food intermediate of claim 31 further comprising two different antimicrobial acids and the salts of the two different antimicrobial acids where the cations of the salts are different.

36. The farinaceous food intermediate of claim 31 wherein the farinaceous food intermediate is selected from the group consisting of cookie doughs, puff pastries, short crust pastries, pie doughs, and yeast leavened doughs.

37. A preservation system for extending the shelf life of a farinaceous food intermediate having a water activity greater than 0.75, the preservative system comprising a mixture of at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids.

38. The preservation system of claim 37 further comprising a chelating agent.

39. The preservation system of claim 38 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

40. The preservation system of claim 37 wherein the two different antimicrobial acids, each independently, are selected from the group consisting of acetic acid, dehydroacetic acid, benzoic acid, lactic acid, sorbic acid, and propionic acid.

41. The preservation system of claim 37 wherein the pH reducing acid is selected from the group consisting of citric acid, malic acid, lactic acid, fumaric acid, succinic acid, tartaric acid, phosphoric acid, hydrochloric acid, and combinations thereof.

42. The preservation system of claim 37 wherein the pH of the preservation system is between 5.2 and 5.6.

43. A method of preparing a farinaceous food intermediate having a water activity greater than 0.75, the method comprising the steps of:
formulating a dough having a water activity level greater than 0.75, the dough including at least a farinaceous flour, water, at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids; and
mixing the farinaceous flour with a mixture of the water, the at least two different antimicrobial acids, the pH reducing acid the conjugate bases of the antimicrobial acids and the pH reducing acid, and the at least two different cations to form the dough.

44. The method of claim 43 further comprising a chelating agent.

45. The method of claim 44 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

46. The method of claim 43 wherein the two different antimicrobial acids, each independently, are selected from the group consisting of acetic acid, dehydroacetic acid, benzoic acid, lactic acid, sorbic acid, and propionic acid.

47. The method of claim 43 wherein the pH reducing acid is selected from the group consisting of citric acid, malic acid, lactic acid, fumaric acid, succinic acid, tartaric acid, phosphoric acid, hydrochloric acid, and combinations thereof.

48. The method of claim 43 wherein the pH of the preservation system is between 5.2 and 5.6.

49. A farinaceous food intermediate having a water activity greater than 0.75, the farinaceous food intermediate comprising flour, water, at least two different antimicrobial acids, a pH reducing acid having a pKa value of less than or equal to 4.5, the conjugate bases of the antimicrobial acids and the pH reducing acid, and at least two different cations where the pH reducing acid is chemically different than the at least two different antimicrobial acids.

50. The farinaceous food intermediate of claim 49 further comprising a chelating agent.

51. The farinaceous food intermediate of claim 50 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

52. The farinaceous food intermediate of claim 49 wherein the two different antimicrobial acids, each independently, are selected from the group consisting of acetic acid, dehydroacetic acid, benzoic acid, lactic acid, sorbic acid, and propionic acid.

53. The farinaceous food intermediate of claim 49 wherein the pH reducing acid is selected from the group consisting of citric acid, malic acid, lactic acid, fumaric acid, succinic acid, tartaric acid, phosphoric acid, hydrochloric acid, and combinations thereof.

54. The farinaceous food intermediate of claim 49 wherein the pH of the farinaceous food intermediate is between 5.2 and 5.6.

55. The farinaceous food intermediate of claim 49 wherein the farinaceous food intermediate is selected from the group consisting of cookie doughs, puff pastries, short crust pastries, pie doughs, and yeast leavened doughs

56. A preservation system for extending the shelf life of a farinaceous food intermediate having a water activity greater than 0.75 and a pH value between 5.2 and 5.6, the preservative system comprising a chelating agent and a reducing agent.

57. The preservation system of claim 56 wherein the chelating agent is selected from the group consisting of ethylene diamine tetraacetic acid, salts of ethylene diamine tetraacetic acid, citric acid, salts of citric acid, esters of citric acid, lactic and fatty acid esters of glycerol, pyrophosphates, hexametaphosphates, polyphosphates, gluconic acid, salts of gluconic acid, tartaric acid, salts of tartaric acid, oxystearin, adipic acid, and combinations thereof.

58. The preservation system of claim 56 wherein the reducing agent is selected from the group consisting of L-ascorbic acid, erythrobic acid, sodium erythorbate, glutathione, sulfur dioxide, sodium sulfite, sodium hydrogen sulfite, sodium metabisulfite, potassium metabisulfite, cysteine, and phenolic antioxidants.

59. The preservation system of claim 56 further comprising two different antimicrobial acids and the salts of the two different antimicrobial acids where the cations of the salts are different.

60. The preservation system of claim 59 wherein the two different antimicrobial acids, each independently, are selected from the group consisting of acetic acid, dehydroacetic acid, benzoic acid, lactic acid, sorbic acid, and propionic acid.
